(19) United States
(12) Patent Application Publication
(10) Pub. No.: US 2017/0246545 A1
(43) Pub. Date: Aug. 31, 2017

(54) SPORTS APP WITH CHAT AND PUSHED EVENT INFORMATION

(71) Applicant: SQOR, INC., San Francisco, CA (US)

(72) Inventors: Brian WILHITE, San Anselmo, CA (US); Noah GIFT, San Rafael, CA (US); Jerold CASTRO, Half Moon Bay, CA (US); Kennedy BEHRMAN, Berkeley, CA (US); Charles PINKERT, Alameda, CA (US)

(73) Assignee: SQOR, INC., San Francisco, CA (US)

(21) Appl. No.: 15/445,039

(22) Filed: Feb. 28, 2017

Related U.S. Application Data
(60) Provisional application No. 62/300,909, filed on Feb. 28, 2016.

(51) Int. Cl. A63F 13/87; A63F 13/35; A63F 13/537; H04L 12/58

(52) U.S. Cl. CPC A63F 13/87; H04L 51/046; A63F 13/35; A63F 13/537

(57) ABSTRACT

A system is disclosed for providing a game chat app. The system may have a source of information regarding a live event, a plurality of user portals, and a network interface. The system may also have a central processing unit in communication with the source of information and the plurality of user portals via the network interface. The central processing unit may be configured to provide a graphical user interface for display on the plurality of user portals, allowing users to chat with each other inside different chatroom environments. The central processing unit may also be configured to receive a selection of at least one of a sport, a league, a conference, a division, a team, or an athlete for following by users associated with each of the different chatroom environments, and to selectively push information regarding the selection into the different chatroom environments based on the live event.

### RELATED APPLICATIONS

This application is based on and claims priority to U.S. Provisional Application No. 62/300,909 filed on Feb. 28, 2016, the contents of which is expressly incorporated herein by reference.

### TECHNICAL FIELD

The present disclosure relates generally to an app (i.e., a downloadable self-contained software application) for use on a mobile device and/or with the web on a desktop application. More particularly, the present disclosure relates to a system for providing a sports app that allows chatting (e.g., between fans and/or between fans and an athlete) and simultaneously pushes to or otherwise allows sharing of event-related information within a chatroom environment. Additionally, the disclosed system may be able to support conversations with a “bot” or artificial intelligence agent that provides contextual information about specific sporting events, sports, and/or players.

### BACKGROUND

An app is an abbreviated term for a “software application”, which is downloadable to and executable by a mobile device (e.g., a laptop, a smart phone, or a tablet). Conventional apps are used for general business purposes, such as scheduling, address booking, emailing, shopping, etc. As mobile devices have increased in popularity and functionality, while also decreasing in cost, apps directed to recreating and socializing have also become available to the public. For example, some apps from sports companies such as ESPN, CBS Sports, and Yahoo provide score updates, breaking news about athletes and teams, professional analysis, live game streaming, and on-demand video. Other apps from social companies like Facebook, Twitter, and Instagram provide a platform for sharing of messages and information (e.g., texts, emails, videos, photos, audio, etc.) between connected individuals or groups of individuals.

Although recreating and socializing types of apps can be independently beneficial, there may also be limitations with their separate use. For example, it may be difficult for multiple parties to socialize with each other about a recreational event, while simultaneously accessing event information normally supplied by recreational apps. In other words, it may be difficult for separate parties located remote from each other to simultaneously utilize multiple apps and experience the same recreational information. This may be especially true when the recreational event is live.

Further, with currently available technology, it is difficult for the sports companies to generate interactive participation with the data made available through only the conventional sports apps. In particular, there is no automatic feedback from consumers about the data that is provided via the apps. And even though the sports-related data may sometimes be independently posted to available social networks, it may be difficult to filter and/or coalesce the data out of the other unrelated information also posted on the same site. Thus the data becomes lost and is useless.

The app and system of the present disclosure solves one or more of the problems set forth above and/or other problems in the art.

### SUMMARY

In one aspect, the present disclosure is directed to a system for providing a game chat app. The system may include a source of information regarding a live event, a plurality of user portals, and a network interface. The system may also include a central processing unit in communication with the source of information and the plurality of user portals via the network interface. The central processing unit may be configured to provide a graphical user interface for display on the plurality of user portals, allowing users to chat with each other inside different chatroom environments. The central processing unit may also be configured to receive a selection of at least one of a sport, a league, a conference, a division, a team or an athlete for following by users associated with each of the different chatroom environments, and to selectively push information regarding the selection into the different chatroom environments based on the live event.

In another aspect, the present disclosure is directed to a method of providing a game chat app. The method may include receiving information regarding a live event, and providing a graphical user interface for display on a plurality of user portals that allows users to chat with each other inside different chatroom environments. The method may also include receiving a selection of at least one of a sport, a league, a conference, a division, a team or an athlete for following by users associated with each of the different chatroom environments, and selectively pushing information regarding the selection into the different chatroom environments based on the live event.

In yet another aspect, the present disclosure is directed to a non-transitory computer readable medium containing computer-executable programming instructions for performing a method of providing a game chat app. The method may include receiving information regarding a live event, and providing a graphical user interface for display on a plurality of user portals that allows users to chat with each other inside different chatroom environments. The method may also include receiving a selection of at least one of a sport, a league, a conference, a division, a team or an athlete for following by users associated with each of the different chatroom environments, and selectively pushing information regarding the selection into the different chatroom environments based on the live event.

### BRIEF DESCRIPTION OF THE DRAWING

FIG. 1 is a diagrammatic illustration of an exemplary disclosed computing system; and

FIGS. 2-6 are diagrammatic illustrations of exemplary disclosed graphical user interfaces that may be used to access the computing system of FIG. 1.

### DETAILED DESCRIPTION

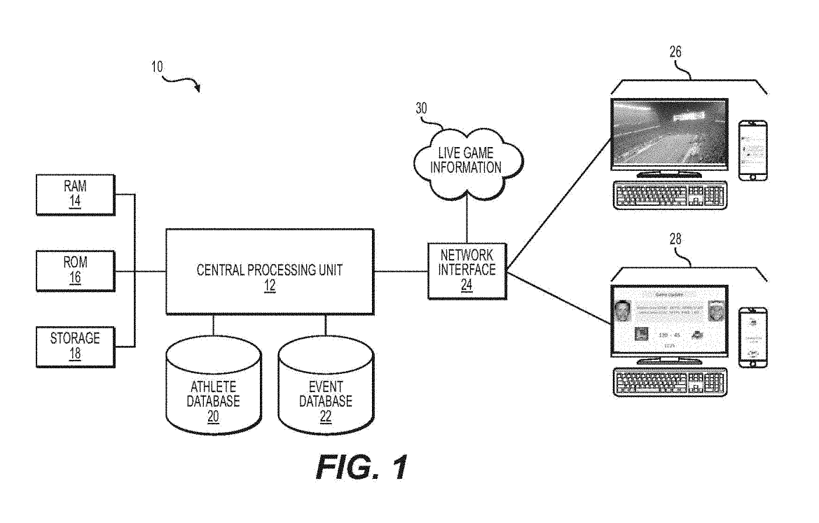

FIG. 1 illustrates an exemplary system 10 that generates, maintains, sends, displays, receives and/or records information associated with the disclosed concepts. System 10 may include, for example, a central processing unit (CPU) 12, a random access memory (RAM) 14, a read-only memory (ROM) 16, a storage 18, at least one database (e.g., an athlete and/or team database 20 and an event database 22), a network interface 24, and at least one user portal (e.g., an athlete portal 26 and a fan portal 28). It is contemplated that system 10 may include additional, fewer, and/or different components than those listed above. It is understood that the type and number of listed devices are exemplary only and not intended to be limiting.

CPU 12 may include an arrangement of electronic circuitry configured to perform arithmetic, logic, input/output, and control operations during sequential execution of pre-programmed instructions. The instructions may be loaded from ROM 16 into RAM 14 for execution by CPU 12. It should be noted that, although CPU 12 is shown and described as a single “unit”, it is contemplated that the functions of CPU 12 could be completed by any number of co-located or remotely distributed and cooperating processing units, as desired. Numerous commercially available microprocessors may be configured to perform the functions of CPU 12. Further, the microprocessors may be general-purpose processors or specially constructed for use in implementing the disclosed concepts.

Storage 18 may embody any appropriate type of mass storage provided to hold information that CPU 12 may need in order to perform the disclosed processes. For example, storage 18 may include one or more hard disk devices, optical disk devices, or other storage devices that provide sufficient storage space.

Databases 20 and/or 22 may contain model data and any information relating to athlete, team, and/or and sporting event records under analysis. The information stored within databases 20 and/or 22 may come from any source 30 known in the art and be provided at any time and frequency. For example, the information could be manually entered based on recorded statistics and/or live observations, automatically retrieved from an external server based on a predetermined schedule, continuously streamed from a supplier site, spontaneously uploaded by users, intermittently pulled from “the cloud,” or obtained in any other manner at any other time and frequency. In addition to the athlete, team, and/or event information, databases 20 and/or 22 may also include analysis tools for analyzing the information stored therein. CPU 12 may use databases 20 and/or 22 to determine relationships and/or trends relating to particular sports, leagues, conferences, divisions, teams, athletes, users, and/or uses of system 10, and other such pieces of information. CPU 12 may pull information from databases 20 and/or 22, manipulate the information, and analyze the information. CPU 12 may also update the information, store new information, and store analysis results within databases 20, 22, as desired.

CPU 12 may communicate with a user of system 10 (e.g., a user accessing athlete and/or fan portals 26, 28) via network interface 24. Network interface 24 may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components. For example, the communication links may include non-proprietary links and protocols, or proprietary links and protocols based on known industry standards, such as J1939, RS-232, RP1210, RS-422, RS-485, MODBUS, CAN, SAEJ1587, Bluetooth, the Internet, an intranet, 802.11 (b, g, n, ac, or ad), or any other communication links and/or protocols known in the art.

Each of portals 26, 28 can include one or more of a router, an Ethernet bridge, a modem (e.g., wired and/or wireless modem), or any other conventional computing components known in the art (not shown) such as a processor, input/output (I/O) ports, a storage, and a memory. The processor of each portal 26, 28 can include one or more processing devices, such as microprocessors and/or embedded controllers. The storage can include volatile or non-volatile, magnetic, semiconductor, tape, optical, removable, non-removable, or other type of computer-readable medium or computer-readable storage device. The storage can be configured to store software programs (e.g., apps) downloaded from CPU 12 via network interface 24 and/or other information that can be used to implement one or more of the disclosed processes. The memory can include one or more storage devices configured to store the downloaded information. Portals 26, 28 may be able to communicate with CPU 12, with databases 20 and/or 22, and/or directly with each other via network interface 24.

Portals 26, 28 may also provide a graphical user interface (GUI) that is configured to display information to users thereof, and that includes a means for receiving input from the user. In one embodiment, an exemplary portal is a computer (e.g., a laptop or desktop computer) having a console and a keyboard/mouse. In another embodiment, an exemplary portal is a handheld mobile device, such as a smart phone or a tablet having a touchscreen display and/or a keyboard. Other types of portals may also be utilized. The GUI of each of portals 26, 28 may allow the user to receive (e.g., visually and/or audibly) information (e.g., athlete information, team information, event information, and information communicated between users) from system 10, to upload information to system 10, and/or to correspond with other users of system 10.

In one embodiment, the GUI of portal 26 is different from the GUI of portal 28. For example, the GUI of portal 26 may be dedicated for use by a contracted athlete (e.g., an athlete having a particular account or contract with a provider of system 10). The GUI of portal 26 may provide a way for the athlete to manipulate (e.g., to allow, block, and/or edit) publishable content or content otherwise distributed to users of system 10 about the athlete. The GUI of portal 26 may also provide a way for the athlete to receive and respond to communications directed from other users (e.g., from other contracted athletes and/or fans) of system 10. Exemplary communications may be written (e.g., texts), visual (e.g., icons, emoticons, pictures, artistic renderings, etc.), audible (e.g., user-recorded and/or selectable pre-recorded sounds or messages), and/or a combination of these things (e.g., video or animation), as desired.

In contrast to the GUI of portal 26, the GUI of portal 28 may be a general GUI for use by any user (e.g., by any fan having a general subscription for services) of system 10. The GUI of portal 28 may inhibit the user from manipulating published content regarding an athlete. This GUI, however, may still allow the user to communicate with other users. These communications may also be written, visual, audible, and/or a combination thereof.

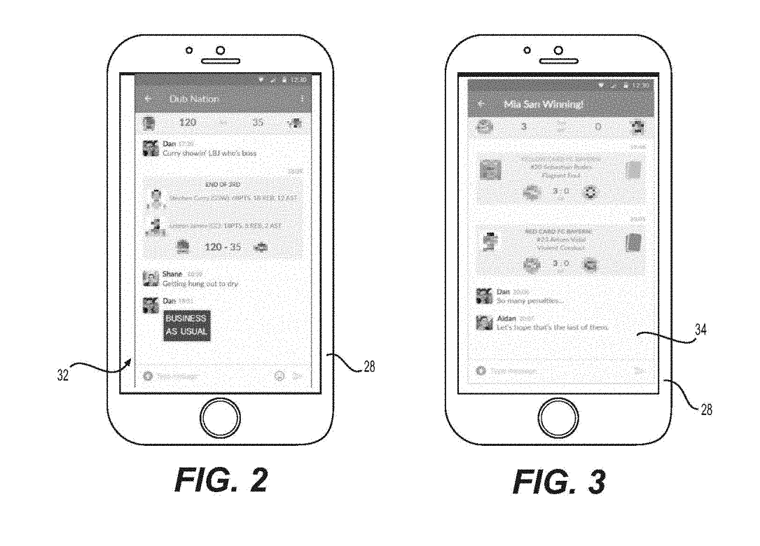

The GUIs of portals 26 and 28 may allow users to network socially with each other (e.g., with other individual athletes and/or fans, with pre-established groups such as fan clubs or teams, with user-defined groups, and others), while simultaneously accessing and communicatively incorporating sports-related information about a historic or live event. FIGS. 2-6 illustrate different exemplary GUIs that may be used for this purpose. FIGS. 2-6 will be described in more detail in the following section to further illustrate the disclosed concepts.

### INDUSTRIAL APPLICABILITY

The disclosed system may be beneficial for any sports enthusiast wishing to communicate with other like-minded individuals or groups of individuals. The disclosed system may allow the typical user to follow a favorite sport, league, conference, division, team, or athlete; to receive pushed alerts about games and athletes, such as scores, injuries, official rulings or decisions, and other updates; to subscribe to exclusive comments from selected athletes; and to share stats and other information about a past, future, or live event. These functions may be accessed via any of the different exemplary GUIs shown in FIGS. 2-6.

A first exemplary GUI 32 is illustrated in FIG. 2 as being displayed on a smartphone-type of fan portal 28. As shown in this figure, GUI 32 represents an available chatroom titled “Dub Nation”. This chatroom may be an existing chatroom to which the user currently viewing GUI 32 has been invited (e.g., automatically invited based on user preferences, profile, prior activity, and/or social media comments; invited personally by another user or athlete; etc.) or, alternatively, a chatroom set up by the current user. The title for the chatroom may be selected by the originator of the chatroom, and corresponds with one or more (e.g., up to five) different sports, leagues, conferences, divisions, teams, and/or athletes selected for following by the originator. In this example, the chatroom corresponds with the Golden State Warriors basketball team. By way of this chatroom, invited participants may send texts, pictures, audio, and/or video to each other. In addition, updates associated with the selected team and/or athlete may be posted to the chatroom. In this example, an update is being automatically pushed into the Dub Nation chatroom regarding a live game involving the followed team. The update includes a short synopsis of the current state of the game (e.g., that the game is in the third quarter, what the score is, and game statistics of the leading player for each team). It is contemplated that the updates may either be automatically posted as they become available (e.g., using a commercially available service that tracks and provides such information), or manually selectable by a member of the chatroom, the chatroom service itself, or by athletes or sponsors, as desired. For example, the update may be automatically pushed or pulled into all chatrooms that are currently following one of the two teams competing in the game based on a predetermined or user-defined schedule (e.g., every 5 minutes). Or, at any time during the game, one of the chatroom participants may request that the update be provided. It is also contemplated that any comments made by a contracted athlete associated with either team (e.g., comments regarding the ongoing game posted via athlete portal 26) may be automatically posted to and/or requested by the chatrooms following either the team and/or the athlete.

In an exemplary embodiment, CPU 12 is configured to determine when to push updates into the different chatrooms based on a comparison of data files stored within either of databases 20 or 22 and received from source 30. The data files may represent a state of the live event (e.g., the FIFA World Cup, the Olympics, or the Super Bowl) and include game information such as a current period in the event, a current score in the event, a current penalty in the event, a current timeout, or other similar game information; roster information such as who is currently in the roster for play in the event, who is currently playing, who is currently sitting the bench, who is currently injured, who is currently fouled out, etc.; and schedule information. When a comparison between a current data file and an earlier data file indicates a change in the game information, the roster information, or the schedule information, CPU 12 may determine a need to push an update to the various chatrooms. In some instances, the particular differences and/or pattern of differences may also dictate which chatrooms to provide with the update. Other strategies may also be employed in determine what and when to update.

FIG. 3 illustrates another exemplary GUI 34 also displayed on the smartphone type of fan portal 28. In this figure, a chatroom title of “Mia San Winning!” is shown at a top of GUI 34, along with a banner immediately below that identifies the teams being followed, an associated event, and a current state of the event. In addition, each time that an official decision is made in the event, that decision may be automatically posted to the chatroom. For example, when a foul is called by a referee, information (e.g., name, number, and/or position) regarding the offending player, the type of foul, the team of the player, and the current score of the game may be automatically posted. It is contemplated that a user could also request that information regarding past decisions be selectively posted to the particular chatroom, such that comments regarding the past decision may be discussed amongst the chatroom members.

In some embodiments, it may be beneficial to create a link between user comments and past occurrences in the sporting event. For example, a user may make a comment regarding a past score or penalty, and desire to link stats, video, and/or other information regarding the score or penalty to the comment so a reader of the comments may be provided with a corresponding context. It is contemplated that this link may be automatically generated, for example based on key words (for example “goal by player 4 in the first quarter”) contained in the comments. It is also contemplated that the link may be generated manually, if desired, for example by making a selection from a list of available occurrences recorded since a start of the event. Other strategies may also be employed.

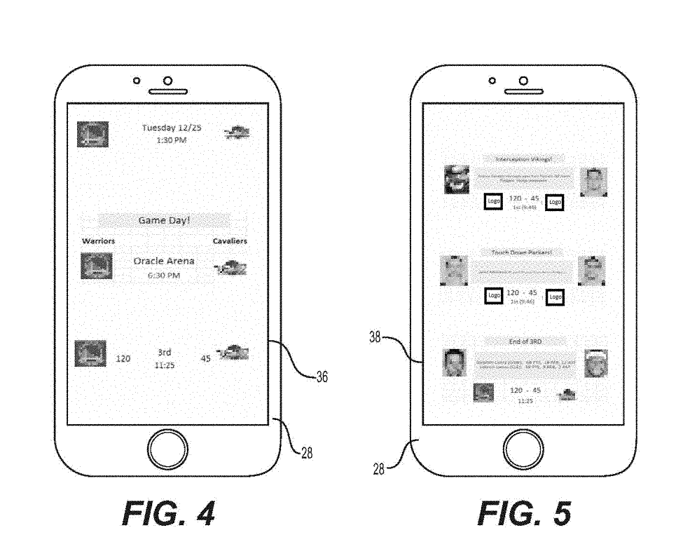

FIG. 4 illustrates another exemplary GUI 36. In this GUI 36, different examples of automatically pushed information are provided. In a first example toward a top of GUI 36, an announcement is being pushed about an upcoming event. The teams or athletes competing in the event are indicated (e.g., by way of names and/or logos), and a location, date, and time of the event are provided. In a second example shown in the middle of GUI 36, an alert is generated indicating that a sporting event involving a followed team is either starting immediately or about to start (e.g., within a predefined or user-selected period of time). Again, the teams competing in the event are indicated, and a location, date, and start time of the event are provided.

FIG. 5 illustrates another exemplary GUI 38. In this GUI 38, additional examples are shown of information that can be automatically pushed to chatrooms based on a change in game status involving followed teams and/or athletes. In a first example toward a top of GUI 38, information is pushed to the chatroom in response to a turnover (e.g., an interception) being made. The information may include the identification of the player making the interception, the identification of the player throwing the interception, which team has possession of the ball, a current score in the game, and a current state of the game (e.g., first quarter, 9:46 to go). Logos of both teams and/or pictures of both players may also be shown in GUI 38. It is contemplated that the logos, pictures and other such standard (i.e., relatively constant or unchanging) items shown on GUI 38 may be stored in and retrieved from databases 20 and/or 22 by CPU 12. Alternatively, source 30 may provide this information, as required. In a second example shown at a center of GUI 38, information is pushed to the chatroom in response to a score being made (e.g., in response to a touchdown). The information may include the identification of the player making the score, information regarding a player assisting the scoring, details surrounding the scoring (e.g., running or passing, yardage, etc.), a current score in the game, and the current state of the game. In a third example shown at a bottom of GUI 38, information is pushed to the chatroom in response to completion of a portion of the event (e.g., in response to ending of a quarter or half of the game). The information may include significant accomplishments or occurrences made during the just-ended portion of the event, as well as the athletes who participated in each one. For example, one or more players may be identified by name, number, and team, and displayed along with a number of points, rebounds, and assists made by those players. Similar information may be provided in conjunction with injuries, questionable calls, penalties, and other similar occurrences. Again, the current score in the game and the current state of the game may also be pushed to the chatroom at this time.

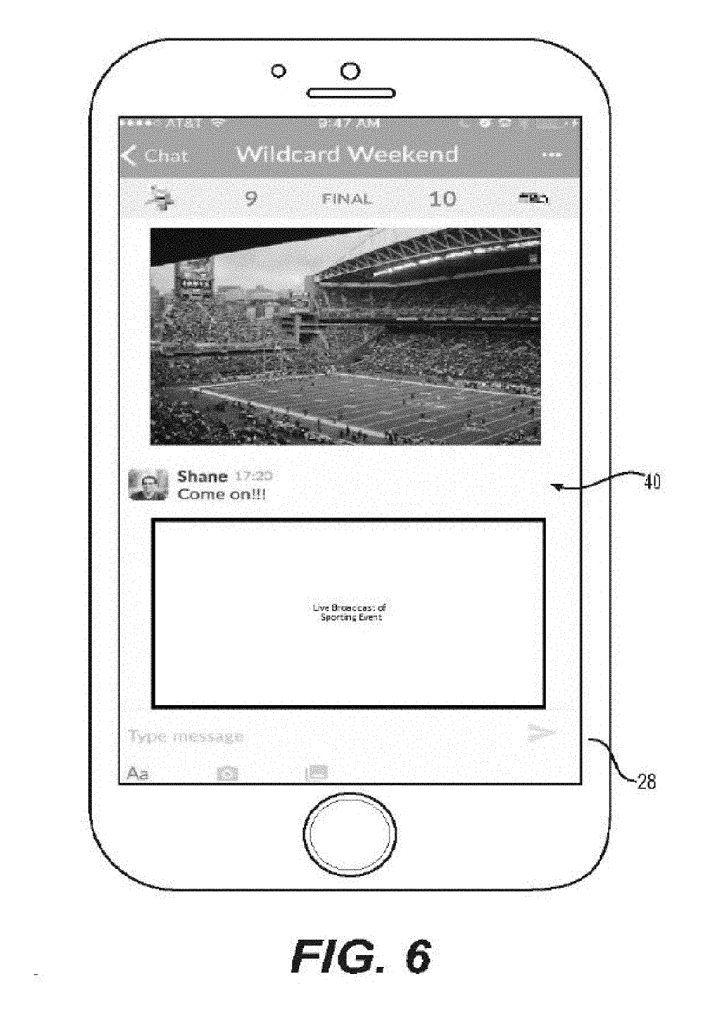

FIG. 6 illustrates a final exemplary GUI 40. In this GUI 40, examples are shown of continuous and ongoing information (e.g., live audio and/or video feed) that can be automatically pushed into select chatrooms. The information could include live video coverage of one or more simultaneously occurring particular events, live commentary and/or analysis of the event(s), and/or other similar information. The information may be pushed from particular external providers (e.g., internet sites, television/cable channels, radio stations, etc.) having a relationship with system 10, from internal system sources (e.g., from internal commentators), from contracted athletes (e.g., via athlete portal 26), or from other providers that are selectable and/requested by the user. The information may be automatically pushed at a start of the event based on the selection of teams followed by the particular chatroom, or pushed only when requested by the user. The information may remain within a visible portion of GUI 40, regardless of commentary between users. That is, the pushed information may remain at a fixed position, as the user's comments, texts, and/or uploaded content scrolls to allow new content to show on GUI 40. Other configurations may also be possible. It is also contemplated that the pushed audio and/or video feed could first be converted to text before display within the chatroom, if desired.

It should be noted that, although the disclosed app and GUIs facilitate chat-type communications between connected fans and/or athletes of the same chatroom environment, the communications could be enhanced by communication with a “chat bot,” in some instances. For the purposes of this disclosure, a chat bot may be considered an artificial intelligence agent that provides contextual information about specific sporting events, sports, and/or players. CPU 12 may function as the chat bot, via portals 26 and/or 28. Communication (e.g., verbal and/or textural communication) with the chat bot may be initiated by a user in response to one or more predefined protocol. For example, a request for a score, information about a player, the data of an upcoming event, what the current quarter is, etc. may be entered (e.g., typed and/or transcribed) into an associated GUI and preceded and/or followed with a particular alpha-numeric character (e.g., #). The alpha-numeric character may defined by the user and/or system 10 and provides an indication to CPU 12 that, rather than the request being directed to another member of the chatroom environment, the request is being directed to the chat bot. And in response to detection of the alpha-numeric character, CPU 12 may provide the requested information (e.g., in the same form as requested) to the corresponding chatroom.

Multiple benefits may be provided by combining social networking functionality with recreational functionality in the framework of a single app. Specifically, it may be easier for multiple parties to socialize with each other about a common recreational event, while simultaneously accessing event information. This may be especially true when the event is live.

It will be apparent to those skilled in the art that various modifications and variations can be made to the disclosed system and associated app without departing from the scope of the disclosure. For example, any combination of the information illustrated on the exemplary GUIs of FIGS. 2-6 may be shown on portals 26 and/or 28 at any time under any condition. Other embodiments of the system and app will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A system for providing a game chat app, comprising:
a source of information regarding a live event;
a plurality of user portals;
a network interface; and
a central processing unit in communication with the source of information and the plurality of user portals via the network interface, the central processing unit being configured to:
provide a graphical user interface for display on the plurality of user portals, allowing users to chat with each other inside different chatroom environments;
receive a selection of at least one of a sport, a league, a conference, a division, a team, or an athlete for following by users associated with each of the different chatroom environments; and
selectively push information regarding the selection into the different chatroom environments based on the live event.

2. The system of claim 1, wherein the central processing unit is configured to selectively push the information into the different chatroom environments based on one of a time before start of the live event, start of the live event, an end of the live event, completion of an official portion of the live event, a score being made at the live event, a foul being made at the live event, or a turnover being made at the live event.

3. The system of claim 1, wherein the information is automatically pushed in to the different chatroom environments based on an elapsed period of time.

4. The system of claim 1, wherein the information includes at least one of an organization name, a logo, a name of the athlete, a number of the athlete, a current score in the live event, a winner of the live event, and a time remaining in the live event, or statistics associated with at least one of the live event, the team, or the athlete.

5. The system of claim 1, wherein the information includes at least one of live audio and live video from the live event in association with the selection.

6. The system of claim 1, wherein the central processing unit is further configured to:
receive from a user of a particular chatroom environment a request for information, in conjunction with a predefined alpha-numeric character; and
selectively return information to the particular chatroom environment based on recognition of the predefined alpha-numeric character.

7. A method of providing a game chat app, comprising:
receiving information regarding a live event;
providing a graphical user interface for display on a plurality of user portals, allowing users to chat with each other inside different chatroom environments;
receiving a selection of at least one of a sport, a league, a conference, a division, a team, or an athlete for following by users associated with each of the different chatroom environments; and
selectively pushing information regarding the selection into the different chatroom environments based on the live event.

8. The method of claim 7, wherein selectively pushing information includes selectively pushing the information into the different chatroom environments based on a status of the live event.

9. The method of claim 8, wherein the status is one of a time before start of the live event, start of the live event, an end of the live event, completion of an official portion of the live event, a score being made at the live event, a foul being made at the live event, or a turnover being made at the live event.

10. The method of claim 9, wherein selectively pushing information includes automatically pushing the information based on an elapsed period of time.

11. The method of claim 7, wherein the information includes at least one of an organization name, a logo, a name of the athlete, a number of the athlete, a current score in the live event, a winner of the live event, and a time remaining in the live event, or statistics associated with at least one of the live event, the team, or the athlete.

12. The method of claim 7, wherein the information includes at least one of live audio and live video of the live event in association with the selection.

13. The method of claim 7, further including:
receiving from a user of a particular chatroom environment a request for information, in conjunction with a predefined alpha-numeric character; and
selectively returning information to the particular chatroom environment based on recognition of the predefined alpha-numeric character.

14. A non-transitory computer readable medium containing computer-executable programming instructions for performing a method of providing a game chat app, the method comprising:
receiving information regarding a live event;
providing a graphical user interface for display on a plurality of user portals, allowing users to chat with each other inside different chatroom environments;
receiving a selection of at least one of a sport, league, conference, division, team or an athlete for following by users associated with each of the different chatroom environments; and
selectively pushing information regarding the selection into the different chatroom environments based on the live event.

15. The non-transitory computer readable medium of claim 14, wherein selectively pushing information includes selectively pushing the information into the different chatroom environments based on a status of the live event in association with the selection.

16. The non-transitory computer readable medium of claim 14, wherein the status is one of a time before start of the live event, start of the live event, an end of the live event, or completion of an official portion of the live event.

17. The non-transitory computer readable medium of claim 16, wherein the status is one of a score, a foul, or a turnover being made at the live event.

18. The non-transitory computer readable medium of claim 16, wherein selectively pushing information includes automatically pushing the information based on an elapsed period of time.

19. The non-transitory computer readable medium of claim 18, wherein the information includes at least one of an organization name of the team, a logo, a name of the athlete, a number of the athlete, or a status of the live event in association with the selection.

20. The non-transitory computer readable medium of claim 19, wherein the information further includes statistics associated with at least one of the live event, the team, or the athlete.
